(19) United States
(12) Patent Application Publication
(10) Pub. No.: US 2006/0178896 A1
(43) Pub. Date: Aug. 10, 2006

(54) Method and system for making connections between job seekers and employers

(76) Inventor: Michael Sproul, Vernon Hills, IL (US)

Correspondence Address: BEEM PATENT LAW FIRM, 53 W. JACKSON BLVD., SUITE 1352, CHICAGO, IL, 60604-3787, US

(21) Appl. No.: 11/054,736

(22) Filed: Feb. 10, 2005

(51) Int. Cl. G06Q 99/00

(52) U.S. Cl. 705/1

(57) ABSTRACT

It is an object of the invention to create a new way of connecting job seekers with employers that will change the way traditional employment searches are conducted by both parties. Our aim is to subordinate the importance of a resume behind or below a more objective matching of a person's personality traits with the desired traits for an available position. This match, along with a set of basic qualification criteria, will be the foundation of the invention's ability to improve both the standard of employment searching and the standard of the final results (successful hires).

### BACKGROUND OF THE INVENTION

1. Field of the Invention

The present invention is directed to a novel method and system for making work connections, which will increase the number and likelihood of connections between job seekers and employers, and consequently reduce levels of unemployment.

2. Description of the Related Art

2.1 Market Needs

The competitive nature of the online employment services market and commoditization of services is a clear indicator that the market is ready for a new approach. The transition of employment services from third party (agencies & recruiters) to the internet is a natural result of a ‘self-serve’ market economy, and this is evident from the rapid growth of the major online job sites. Also, all indications point toward growth as the economy stimulates companies' hiring activity, and employees seek better employment. Seen together, it is a reasonable conclusion that online job sites will play an expanding role in the job seeker's and employer's needs for connecting.

However, the current ratio of resumes to online jobs is at least 50:1, with many sites boasting the “millions of resumes” they contain. Resumes are difficult to decode, and many hiring agents are forced to funnel data into standardized applications, leaving many applicants even more pressed to distinguish themselves from one another. The rise of software programs promising the sifting of resumes does little to find the right person for a job as they remove any remaining nuances of personal style from the applicant's profile. The hiring agent must then interview twice as many people to find an individual with an appropriate work style for the job and company, as well as the required skills. It is very difficult to stand out amongst a group of e-mails.

From the job seeker's point of view, applying for jobs online can feel like throwing pennies in a wishing well, with little expectation of anything back. The impersonal nature of automatic emails and inconsistent or nonexistent response from job postings can even provide a false sense of hope when in fact most of the time the hiring agent never even sees the applicant's response due to automatic filters.

There is a need for a better way to establish qualification for a particular employer's needs of work or job. Creating a pool of qualified applicants and then presenting to the employer the ones that meet a definition of a preferred work style for a particular job will:
Shorten the process of finding truly qualified applicants.
Decrease the number of interviewees and interviews required.
Change the focus from the resume to the candidate, where it needs to be.
Help the hiring agent uncover the true traits & attributes needed for a position.
Help the job seeker understand their own strengths and weaknesses for different types of work.
Help More People Find Work & More Employers Find The Right People.
Help minimize discrimination of gender, sex, age from initial candidate review.
   The invention, and the way it works, is therefore offering a new way to find work/job seeker matches, selling relief from stress of resume review and resume creation. We are making it fun to find work, and helping people discover themselves and their most marketable traits and talents.

2.2 Market Summary

The market for Employment Services in the U.S. has an excellent outlook from now until at least 2007, with growth expected from a large economic recovery fueling several changes in the landscape for both job seekers and employers. The number of new jobs is expected to increase by 21.3 million jobs, or 15 percent by 2007, and the number of available candidates is expected to drop, making the need for employment services surge. Employee retention will become key again, as more movement between companies is expected. Frozen hiring policies will thaw, and there will be a churning, due to levels of dissatisfaction in the workforce (with salaries, and long-endured cut backs). Many companies have halted or decreased hiring for 2 years or more since 2001, and the need to fuel regrowth with an expanded workforce is increasing.

2.3 Market History—U.S. Employment Services:

The Employment Services industry is big, growing and changing. Want ads and recruiters used to dominate the lucrative job sourcing market, ignoring the internet as a threat due to its ‘inhuman’ nature—until 2001, when many companies froze hiring. The landscape has never been the same for recruiters, and the ensuing changes opened up huge opportunities for online applications.

Market size (online & offline) grew 1.8% from US$119.6 billion in 2002 to US$121.8 billion in 2003. Online only sales were $820 million dollars in 2003, with www.monster.com owning 52% share, Careerbuilder 26%, and Hot Jobs at 10%. There is plenty of room for growth as the market is expected to grow.

Market sectors: temporary help supply services remain the largest sector in the US Employment Service Market, accounting for 83.2% of the total market in 2003. The area is dominated by recruiting companies, Manpower, Addeco, Heidrick & Struggles. The total online share of the market in 2003 was only 9%, but it is growing. Office support is the largest category, accounting for 34.6% of the total temporary help service. However, an online service, CareerBuilder.com, was the fastest growing company in terms of revenue, up 155% in 2003 over 2002.

In addition to Manpower Inc. and Addeco, other brick and mortar service companies include Kelly Service, CDI Corporation and Randstad Holding NV.

Global outlook: There are over 200 million Internet users in the US, which implies 50% online penetration; of those, 25% use a broadband connection. While the infrastructure and economics in the U.S. are more favorable than in many other countries, there are nearly 600 million Internet users outside the US, with broadband penetration in other countries ranging from 0%-60%

2.4 Replacement Needs—‘Aging Baby Boomers’

(US Bureau of Labor Statistics) Between 2002 and 2012, the Bureau of Labor Statistics projects that 35 million workers will leave their occupations permanently and will need to be replaced. These replacement needs are the largest source of job openings for workers entering most occupations. By the time the average worker is 35, they have worked for 9 different employers. This younger workforce is dependent upon technology for their job search more so than ever before. Coupled with the expectations of growth in both internet users and the number of people looking for jobs in the next 8 years, Online job searching should experience a real surge in growth.

“Workers empowered with multiple job offers, and fed up with bosses who “just don't get it,” will seek work elsewhere, she says, making the corporate world's scramble for skilled employees in the late 1990s seem like a warm-up session.

“Employees are going to be jumping from job to job as never before. We're going to have a lot of people in a lot of different businesses who are not able to be as efficient and effective as their predecessors were. We're going to feel like we're not enjoying the same standard of living that we once had.

“Take this for example: You buy groceries at your friendly local food store, and have come to depend on the person behind the fish counter. You show up one day to buy your fish, and that person is no longer there because he's changed jobs. The person who is there doesn't seem to know what he or she is doing, and furthermore, doesn't really care much about you. And you're not the only [one] who feels that way. There are other customers who feel the diminution of services, and they choose not to go there any more. Now that store is in trouble. Because it cannot find good people to serve its customers, its sales drop. You go back again, and not only is there not a nasty person behind the counter, there's nobody behind the counter, and you have to call for somebody to help you.”

“When the economy turns around, you will see a massive churning in the labor market.”—Joyce Gioia (article involving Gioia study of an expected upcoming labor shortage in the U.S. in the CS Monitor January 2003).

“Approximately 72 percent of people who are employed in the United States today don't like their jobs. When the economy turns around, you will see massive churning in the labor market. For employees, there is definitely a silver lining here. They are going to be more highly valued by the employers that are getting it; the ones that we call ‘employers of choice.’ Employers who are not employers of choice may still be able to stay in business, but they won't be nearly as profitable. They're going to be spending a ton of money replacing people. Employee turnover is extremely expensive. If companies understood that, they would be nicer to their people.” Employment Policy Foundation, employment forecast, Oct. 23, 2001, p. 2.

“Only the most progressive organizations agree turnover costs money. They make every effort to determine why people leave, and strategically plan to retain top talent. If an organization experiences high involuntary turnover, then it is hiring the wrong people. Most employers hire (and most employees accept jobs) based on a match in skills. However, most employers fire (and most employees quit) based on problems with organizational fit. Consider hiring for organizational fit in addition to matching skills.”

Society for Human Resource Management, Workplace Visions, No. 1-2002.

2.5 Competition Overview

There are some 1,746 websites that offer employment connections, networking, and techniques. Most of these sites fall into the “Job Search” category, although there are a few that do not, for example, those that offer so many diverse services that they are categorized under general ‘Employment’, such as Monster with its 1200 internet pages. Also, there are some enormous brick and mortar companies, especially the global placement firms and temporary firms, like Addeco of Switzerland, Heidrick & Struggles of the U.S. and Manpower of the U.S., with thousands of employees worldwide, and a focus on human resources.

2.5.1 Monster.com

World's top job search web site in traffic, jobs posted, resumes posted and revenue. Sales growth 2002-2003 was 1.9%. 875 employees power Monster, which derives most of its revenue from Employers. Every day Monster.com reaches approx. 5% of all internet users. It has become an enormous warehouse of information, and its complexity is turning off some users as evident by the recent surge in growth of its nearest competitors. 2,570 sites link to monster.com and almost 1 in 5 sessions have pop-up ads. A big target it is, too. Slow to move, and steady in its placement. Colorful, easy navigation, but one soon gets lost within the 1200 pages and the success rate is heavily favored to the employers.

Monster also owns new jobs.com, betheboss.com, monsterboard.com, monsterjobs.com, tmpservice.com, tmpw.com, cadencecafe.com, monsterjob.com, monstertalent.com, monsterhealthcare.com, monstermoving.com, and chiefmonster.com.

2.5.2 CareerBuilder.com

CareerBuilder.com started life as an online version of the Chicago Tribune's want ads and grew to be a joint venture of Tribune, Gannett and Knight Ridder publishing companies' portal of 400,000 job openings with 8 million resumes from across the U.S. It is quickly gaining ground as a job warehouse without all the gimmicks of Monster.com, as it's monthly site visitors number is up 112% over this period last year when CareerBuilder signed partnerships with AOL and MSN, replacing Monster. CareerBuilder's internet reach is approx 6%. 5 million visitors/month separates CareerBuilder from Monster.com. CareerBuilder.com also owns: headhunter.net, sologig.com, careermosaic.com, headhunter.com, careers.com, headhunters.net, miracleworkers.com

2.5.3 Hotjobs.com

Hotjobs.com, Ltd. 24 West 40th St., 14th Floor, New York, N.Y. 10018 US 212-302-0060 sales@hotjobs.com. Is a part of Yahoo. Yahoo's strong brand recognition and the Internet's largest user base has bolstered HotJobs strength and position into the top tier of internet job site competitors.

2.5.4 ASP's & Software for Hiring/Recruiting

In response to the boom of internet job searching, many recruiting and staffing firms have turned their attentions to creating automated processes to filter resumes and match candidates with jobs. An inexact science, it virtually requires resumes to become more alike each other for the results to compare each one equally. Errors and misjudgments run rampant, and a whole new industry has arisen to people helping coach applicants through creating a resume that ‘complies’ with these search tools. In addition, many of the large online job sites have created a filter tool to help hiring managers cope with the deluge of resumes, and they use this to ‘differentiate’ themselves from the competition i.e. HotJobs' “Agency Exchange” program.

Some of the companies devoted to process automation are: IdealHire, Inc. www.idealhire.com ASP that automates & manages hiring & recruiting process web based “PowerMatch” software for resumes submitted to corporate sites and eliminates unqualified candidates.

ExecGlobalNet www.execglobalnet.com A ‘matchmaking’ service does not use resumes, focuses on executive levels and the anonymity of this search. Their product is the discreet nature of the match, and does not consider traits or personality types.

Brass Ring LLC www.brassring.com Recruitment software and workforce management “Enterprise” software automates hiring process. Partner to CareerBuilder.com.

Kenexa (TalentPoint) www.kenexa.com. Web based applications that automate recruitment, skills testing & management processes, training materials, etc that maintain the look and feel of the client's website.

TruStar Solutions, Inc. www.trustarsolutions.com, web-based recruiting services, WetFeet, Inc. www.wetfeet.com. Hosts online recruiting sites, screens applicants, distributes job listings & recruitment marketing.

Hire Success www.hiresuccess.com. Pre-Employment testing tool that attempts to discredit using solely Myers-Briggs.

2.5 Government Online Job Sites

Assessment.com: The online version of the MAPP (Motivational Appraisal of Personal Potential) test that assesses motivations to determine work that someone will love doing. People take the 71 question test and can see some results, and buy the hugely verbose report for $19.95. For $29.95, customer gets top 10 job “matches”, which is actually job type matches, not actual jobs. There is a recruiter's link on this page that will remember customer field match, ask 5 more qualifying questions and actually retrieve real jobs, however the two mechanisms of profiling and job search seem entirely unconnected. In addition, this entire process is based on what someone would like to do, not personality traits or how their profile affects job performance.

O*NET: The Occupational Information Network, a major initiative of the United States Department of Labor, is a comprehensive database of worker attributes and job characteristics. Hundreds of professional associations support O*NET, which helps employers meet human resource challenges by identifying front line skills necessary to succeed in their fields, and helps job seekers understand the skills and training they need for the jobs they want. The O*NET system serves job seekers, students, businesses, and workforce investment and human resource professionals to help them make informed employment, training, and business development decisions. O*NET creates the opportunity for common standards and logic/language connection to job search banks. . . O*NET OnLine offers universal accessibility through a single online site.

2.6 Other HR Resources

2.6.1 AIRS

Founded in 1997, AIRS began life as a training firm, offering seminars to help recruiters find passive candidates hidden among the 250 million people on the Internet. Once controversial, AIRS active search techniques are now mainstream recruitment methods. Today, AIRS Training offers seminars and workshops that span the e-recruitment landscape, with more than 2,000 public seminars and corporate trainings.

2.6.2 The Electronic Recruiting Exchange (ERE)

Founded as an email discussion list for recruiting professionals in February 1998, the ERE has grown to become the pre-eminent source of information and networking opportunities for recruiters and HR professionals on the Internet.

2.6.3 Human Resource Executive

Human Resource Executive was established in 1987 and continues today as a leading publication focused on strategic issues in HR. Written primarily for vice presidents and directors of human resources, the magazine provides these key decision-makers with news, profiles of HR visionaries and success stories of human resource innovators. Stories cover all areas of human resource management, including personnel, benefits, training and development, HR information systems, relocation, retirement planning, workplace security, and healthcare.

2.6.4 The International Association for Human Resource Information Management (IHRIM)

The International Association for Human Resource Information Management (IHRIM) is a link to the unique world of HR information management, systems issues, trends, and technology.

2.6.5 Society for Human Resource Management (SHRM)

SHRM is one of the world's largest associations devoted to human resource management. Representing more than 170,000 individual members, the Society's mission is to serve the needs of HR professionals by providing the most essential and comprehensive resources available. Founded in 1948, SHRM currently has more than 500 affiliated chapters within the United States and members in more than 120 countries.

2.6.6 Staffing.org

Staffing.org is an independent nonprofit corporation and leading proponent and provider of standard HR performance metrics. As a provider of weekly updates and monthly HC Metrics newsletters, they provide practical, succinct advice and perspectives, as well as information on the latest human capital performance developments.

2.6.7 Workforce

Workforce Magazine—HR Trends and Tools for Business Results.

2.6.8 Workindex.com

Workindex.com is a link to a comprehensive index of workplace-related Web sites, HR tools and information. The site is produced and maintained by the publishers of “Human Resource Executive”, in cooperation with Cornell University's School of Industrial Labor Relations. Workindex.com offers news and editorial with three sub-sites devoted to staffing, training and benefits. Tools include a salary calculator, software tester, legal clinic and events calendar. Visitors can search and post jobs, participate or read results from a monthly poll and download free business forms. Access to the site is invaluable to corporate HR professionals, top executives, line managers, job seekers and students.

No job site or company that we can find connects job seekers and employers using trait or personality indicators or anything other than resumes or filters of location, industry or salary level.

### BRIEF SUMMARY OF THE INVENTION

It is an object of the invention to create a new way of connecting job seekers with employers, that will change the way traditional employment searches are conducted by both parties. Our aim is to subordinate the importance of a resume behind or below a more objective matching of a person's personality traits with the desired traits for an available position. This match, along with a set of basic qualification criteria, will be the foundation of the invention's ability to improve both the standard of employment searching and the standard of the final results (successful hires). This matching service can be described as a hybrid of dating connection services and job networking services, and is the principle product that the invention provides. It will be sold online in a virtual community, on a website.

Another object of the invention is to have job seekers who receive unemployment benefits from the government enrolled in our service, together with those already employed, yet seeking a change.

Another object of the invention is to create a more positive work-seeking experience for employees, either permanent or less than permanent, all of whom can contribute greatly to the economy, and to create an environment of equivalence of all employees in whatever category.

Another object of the invention is to enter the online employment market as a new, more effective, less expensive alternative to traditional job connection methods. the invention will emulate sites “of the people, by the people, for the people” (like eBay).

These and other features and advantages are evident from the following description of the present invention, with reference to the accompanying drawings.

### BRIEF DESCRIPTION OF THE SEVERAL VIEWS OF THE DRAWINGS

FIG. 1 is an overview of a website map, showing hierarchy and levels of various functions in an exemplary embodiment of the invention;

FIG. 2 shows the structure and functionality of a website home page;

FIG. 3 shows a screen where a job seeker starts the process of discovery about the site

FIG. 4 is a screen shot of a job seeker member's home page, after registration;

FIG. 5 shows a screen where an employer starts the process of discover about the site; and

FIG. 6 is a screen shot of an employer member's home page, after registration.

### DETAILED DESCRIPTION OF THE INVENTION

3.0 General Description

The invention will be described with reference to its use in an internet employment system, designed to essentially re-invent how work connections are made, increase the number of those connections between job seekers and employers, and consequently reduce levels of unemployment.

This novel system is capable of bringing employers and would-be employees together in a non-traditional, but more useful and realistic way, using tried and tested personality methods that are often used when an in-place employee is being considered for advancement within the organization. The novel system of the invention will provide these services at a significantly lower cost to the hiring process of existing internet job search sites.

The invention provides a better way of connecting job seekers with employers, based not on a traditional resume alone, but on the true, innate, qualities a person has that enable him to excel in a job. The invention has created a successful ‘matching’ mechanism in an online forum that is convenient, easy, fun, fair, private, and affordable for both job seekers and employers.

3.1 Features

The invention offers to its users:
The pursuit of increased success of qualifying candidates for actual available positions
Shorter, faster, higher quality candidate searches
A private forum for communication
An advanced job connection method for all types of job seekers
A national networking opportunity for job seekers
A more objective and honest way to match qualified job seekers with jobs
A helpful, uncluttered and vibrant online environment
Fast help and response to problems and questions
A commitment to listening to and incorporating worthwhile suggestions & feedback to improve customer experience

The invention offers a website (eBullpen). The website's success depends on return usage, and therefore will show continued value to its users. The invention will provide a populated job seeker database quickly that will immediately generate matches for employers. It will show value for job seekers with a knowledge base and other features, such as networking.

For employers and job seekers to understand and rely upon the match, a portion of the website will be dedicated to the education of users on the subject of personality and its application to the hiring process. It is important for this idea to become adopted as the better way to a successful hire. However, the site will not solicit information on race, gender, age, or marital status beyond what the government regulations may require and then only for that purpose. Rather, it will use non-judgmental techniques of bringing people together.

The embodiment of the invention described herein is an internet based job connection service that matches job seekers with employers seeking to fill jobs. Job seekers are invited to place their profile on our database by taking a simple personality test, and providing desired work geography and general work experience. Job seekers pay a periodic fee (e.g., monthly) for their profile to be included in the database. Our customers will be job seekers and employers. Employers will be charged to register and then a per specified opportunity, subscription-based fee. The website will be set up to require little or no human intervention in the matching of job seekers and employers.

The website will allow employers to define opportunities and perform searches based on qualities that will determine success in the job. These qualities will be represented by the individual's personality traits, combined with criteria that determine desired work area and geography, along with a general work experience profile. Employers define opportunities by taking a somewhat mirrored version of the job seeker's personality test to determine the personality they are seeking for specific work. The results of the search are posted in terms of percentage match to the requirement. Employers pay a fee to register to use the site and are offered, on a variable fee scale, several options, e.g., one opportunity definition and one database search match, a given number of opportunity definitions with unlimited searches for 30 days, or a greater number of opportunity definitions with unlimited searches for one year.

The most widely acknowledged personality indicator is a public domain device known as “The Big 5”. It claims to improve upon the Myers Briggs Type Indicator (MBTI®), and offers 5 scales for measure of a person, instead of the Myers Briggs 4. These measures are Extraversion, Openness, Conscientiousness, Emotional Stability, and Agreeableness.

Combinations of these preferences result in a multiplicity of personality types. Understanding these characteristics provides insight on how they influence an individual's way of communicating and interacting with others.

The full range of information that will be searchable in the database will be zip code, area of knowledge (marketing, accounting, consulting, etc), industry (aeronautical, automotive, pharmaceutical, etc), character type, rate of pay, recent level within a company (manager, director) a preference of type of work (p/t, f/t), and preference of being considered only for employment, or only for independent contracting, or no preference.

3.3 Other Information

Other information will be retained by the site, such as full name, e-mail address, physical address, credit card information, any statistical information that the government requires us to collect, and also a password to match the usemame, which will be their e-mail address. This information will not be released to employers or job seekers.

Alongside the services offered, the website will offer a large knowledge base of information on the subject of employment, networking opportunities, news and realistic statistics, based on the on-site activity, of users' chances of being matched. If, in running the search engine, no or too few close matches (less than 5 at 90% or better) come back from the database, the website will ask the employer if he wishes to save this search at no charge, and have it re-run automatically until there is a population of the right people, and then be notified.

Both parties need to be aware what the site is responsible for and what it is not. It is not responsible for getting a member work, nor for finding the employer a worker. Consequently, nobody is charged in the situation that a hire happens. Nor does the invention make any endorsement of the job seekers or employers on its site. The website is responsible for bringing interested job seekers and employers together in a useful and safe environment. The invention provides a website for the purpose of connecting job seekers and employers, in a new way that compares a person's personality preferences with personality preferences defined by employers in terms of work practices. The current landscape for employment is very positive, with a good outlook for growth in the economy, internet, the volume of job seekers and employers, and other factors such as labor shortages causing a churn in the labor market.

As indicated above, the invention offers a new way to hire and seek work in the information age of the internet which will streamline the process of connecting work job seekers and employers. It uses personality-type testing to determine the attributes an employer is looking for in a candidate, and a test for a job seeker to discover the attributes that they offer.

Overall, the invention is an excellent product with which to enter the exciting U.S. employment services market. The market is on the verge of dynamic growth, and internet usage is ever-increasing. Our strengths and opportunities clearly outweigh our weaknesses and threats, which we are well prepared and positioned to address, should they develop.

3.4 Strengths
1. New way of connecting job seekers and employers. No job site or company that we can find connects using personality traits or anything other than resumes or filters of location, industry or salary level.
2. Less expensive than competitive sites for posting jobs, with little, if any, advertising, but will contain similar useful information content for job seekers.
3. Advanced job connection method does not require a resume—we connect people with people, not jobs with resumes.
4. The invention is a more objective way of matching job seekers and employers that minimizes discrimination.
5. Our test will have the credibility of being either an existing acceptable, known type testing method like Myers-Briggs or an adaptation or creation from recognized sources, endorsed by a professional with impressive credentials in the field of industrial organizational psychology.
6. The invention can devote all of its focus to serving its online customers and will have a cleaner, uncluttered, and easy environment.
7. All users will have paid subscriptions—no posting of junk jobs or multiple resumes.
8. Our assessment test process helps job seekers and employers learn about themselves and the true drivers of success for a given job opportunity.
9. Our assessment mechanism will decrease the qualification pool without mechanical keyword searches, resulting in a quicker, more productive search that produces more qualified applicants.

3.5 Customer Need

Increase connections between job seekers and employers. Provide an easier way for qualified candidates and employers to find each other. The current process that has evolved online has reduced individuals to a form that is searchable by keywords. It discourages the truth and often complicates the search process for both parties leaving dissatisfied job seekers and employers with ‘information overload’ or ‘communication void’.

People are now represented electronically, and often misrepresented. Jobs seem unattainable and surreal, and rarely is there any human communication in this process of automatic responses.

The invention matches Full-Time, Part-Time, Temporary, Contract, Intern or Volunteer job seekers and employers, online, using personality qualifiers in place of a resume. This approach to connecting job seekers and employers allows for broad application across all industries and types of employment. It is entirely possible for the site to become vertically segmented in the future, if customer response indicates it to be beneficial. The invention's matching method combined with the self-service nature of the site make it unique among job search sites. The process of matching does not involve resumes, nor does it involve a middleman “matchmaker” as some recruiter services provide.

Rather, an automatic, objective match between the personality type of the job seeker with the type defined by the employer will be the primary mechanism. The system, by providing comprehensive matching of all job requirements, ensures solid matches at the top tier of employers' search results. By placing the importance of the personality factors ahead of the resume, the more difficult aspect of matching workers with work, or an organization's culture gets substantially easier and the pool of qualifying workers that an employer will like gets substantially smaller, thus decreasing the search time and increasing the success rate of matching employers and job seekers. The invention will have two dimensions to its website each with a corresponding ‘product line’. Establishment of each product line is necessary for the success of the other.

One aspect of the invention is the job seeker's portal. To achieve maximum credibility, we wish to attract only serious job seekers willing to invest some time and money into our system and will strive to show return for investment. We do not wish to have a site populated with resumes, and do not intend to have a resume uploading facility (that may come later on in the hiring process, at the parties' discretion.). We want each registrant to feel a unique place on the invention. Registration is required for job seekers, and a monthly subscription fee is charged. Subscriptions can also be purchased for other amounts/durations.

3.6 Benefits

3.6.1 Job Seeker Benefits:
Access to subscriber content, articles, newsletters, links, and information.
Subscription to eBullpen “watercooler” network of job seekers.
Results of personality test and its application to the job search.
the invention e-mail access and folder management.
Addition to the job seekers' database and qualification for employer search matches.
Access to private direct instant messaging and management of conversations with employers.
Customized content “my Bullpen” page.
Indicator of numbers of job seeker matches with employers.

Another aspect of the invention is the employer's portal, which educates about hiring with Personality and allows and invites employers to take the personality test that job seekers take. Employers must register for a fee to define job opportunities. They can run a search after defining an opportunity, however to access the job seekers they must pay a search subscription level. Based on the amount of a prepaid usage fee, they can then search the invention talent database for a one-time fee for one opportunity, choose unlimited searches on a set number of opportunity definitions (e.g., 5 within 30 days), or unlimited searches for a larger number of opportunities (e.g., 100) within one year. Each of these subscriptions are easily renewable.

Based on the parameters of qualifications set by an employer, (which include personality type as determined by a short questionnaire of desired worker traits for the position, location, experience, salary and type of work (F/T, P/T, etc), a list of qualified job seekers in the invention.com database will be returned in order of percentage of qualifications matched.

3.6.2 Employer Benefits:
Access to Corporate content on hiring, advice, guidance, resources, links, etc.
Opportunity definition assistance.
Opportunity management and custom content on “my Bullpen” page.
the invention ‘email’ account and folder management.
Access to personality test results, using type in the hiring process.
Full database search capabilities within opportunity parameters and subscription allowance.
Job seeker contact initiation via email and instant chat sessions, in the Virtual Interview Room.
Management of emails, chat sessions and opportunity progress.
Search result candidate-analysis by factors matched.

Most of the employment sites online must try to differentiate themselves by specializing in one aspect of searching, and the more successful ones create software, or onsite tools, to help employers deal with the deluge of applicants that must be sorted. Of the web sites available offering direct work searches between the job seeker and employer, there is apparently none offering anything like the present invention. The invention is novel in the following ways, among others:
We are a new concept in employment/employee searching that does not use traditional resumes and is effective, nonetheless.
We are the first to use an automated system that provides best matches for a job that uncovers the true candidate instead of how well their resume matches the job specification. Truly qualified applicants are selected as matching, not their resumes: we match people not paper.
   We are considering allowing the employer to ‘weight’ his search by choosing the relevant importance of the demographic factors involved in the search, such as geography, or peoples' experience in a particular discipline. He will not be permitted to choose weight attributed to the trait indicator, as this would generate erroneous results.

4.0 Detailed Description

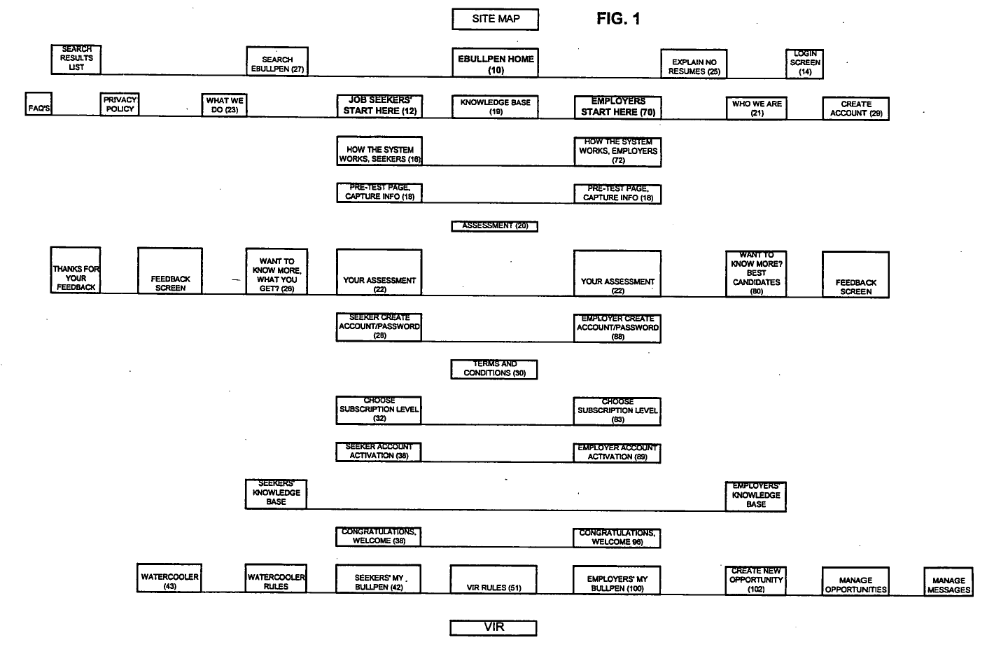

FIG. 1 is a website map of the embodiment of the invention described below.

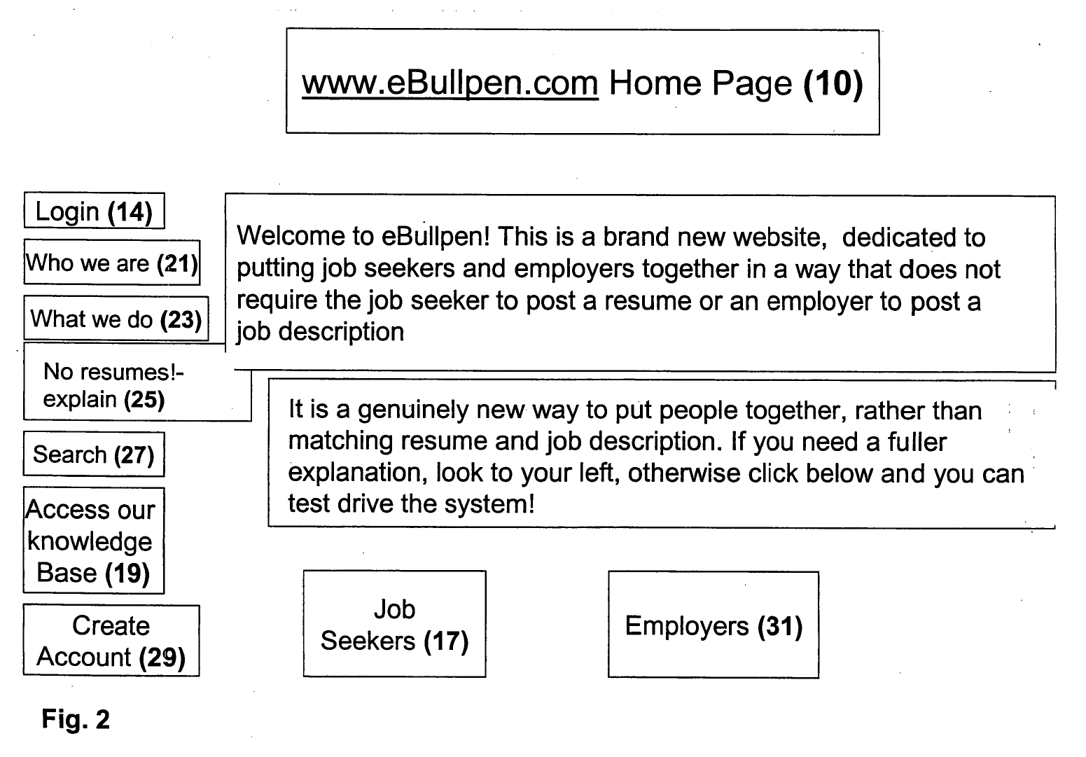

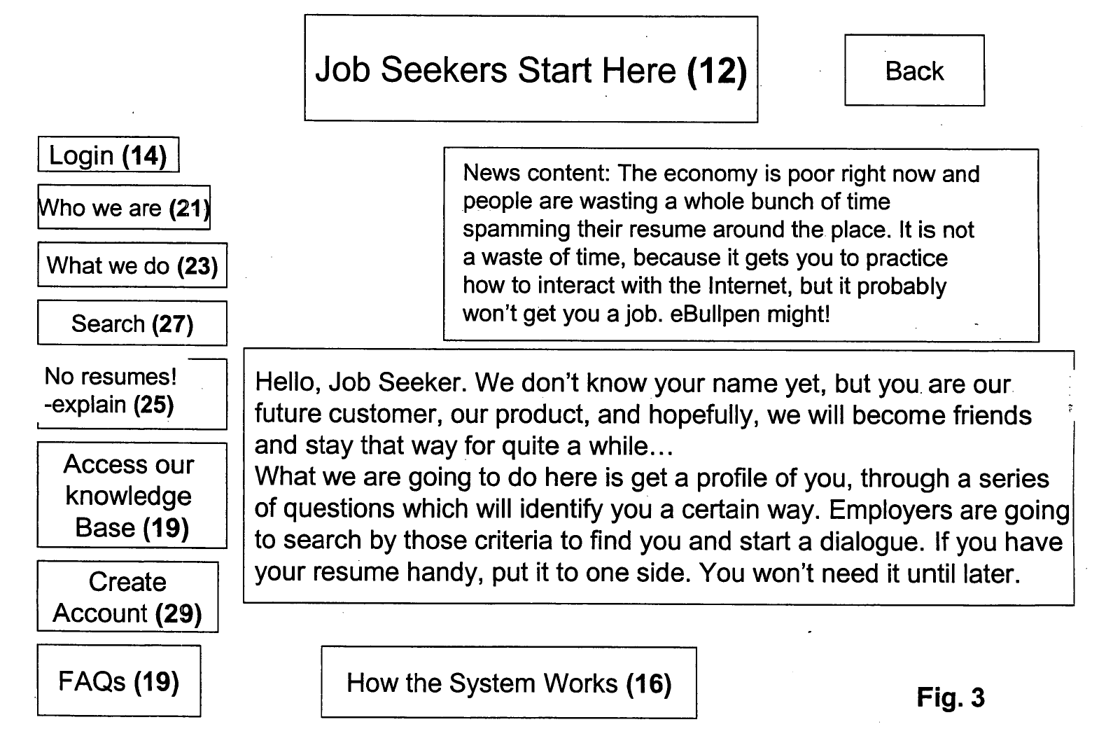

Referring to FIGS. 1a and 2, when someone enters the website “Home Page” at screen 10, they identify themselves as a job seeker or employer. If the person is already registered, they enter their own page 42 through a login screen 14. If a new job seeker selects “Job Seekers” 17, in FIG. 2, it brings up a “front page” 12 “Job Seekers Start Here” (see FIG. 3) and further screens explain the process, and then sequence through it, as described below. From this “home page” 10, one can also access a searchable “knowledge base” if desired, by selecting “Access our knowledge base” 19. Other selections include “who we are” 21, “what we do” 23, “no resumes—explain” 25, “search” 27, and “create account” 29—.

Selections 21, 23, and 25 bring up screens which explain: “We collect information, via a simple test to determine a person's personality traits. We then take other general information regarding a person's geography, department, industry, and level and put that away in a database, but ready at a moment's notice, waiting for an employer to specify these or very similar criteria. We allow the employer to search our database of profiles and produce a list of potential matches in order, closest match first. A dialogue can then start between the employer and those people to whom his definition is matched. We do not match resumes with job descriptions, but rather match people with people.”

“Resumes are an important element of a job search, but we don't believe it should the first and only thing that an Employer or a Recruiter looks at. First, let's get somebody who is a ‘Fit’ for the position, in terms of their character, and a fit for the company that is looking to recruit. The upside for the employer or recruiter is that this way, he won't have to look at as many resumes, and he won't have to interview as many people.” The user may also select options 19, 21, 23, 25, 27 and 29 (see above) from screen 12 (FIG. 3). Screen 12 also offers a “back” option 31, as well as “FAQ's” 19, and “How the System Works” 16 & 72.

Screens 16-18 explain: “eBullpen will give you a short (15 minutes, max) test, which you should answer as truthfully as you can in order for the system to work effectively. This will establish your personality traits, and tells people how you see and react to the world. The good news is that there are no wrong answers to the test. We'll give you a summary result, and then ask you to subscribe to our site for $10 for a month's listing in our database. If you subscribe, we will pick up your geography (zipcode), preferred Industry to work in, preferred discipline (marketing, accounts, etc) level you have reached (worker, manager, director, VP, etc.), minimum salary level you desire (assuming that somewhere along the line, you would need to justify that), type of work (F/T, P/T, Temp, Independent Contractor), and your credit card information. Once subscribed, you get into your own area of the bullpen, where you can see activity, chat with others, get into a Virtual Interview Room with somebody who has found you.”

“Over the next four screens (20), you will be shown about 50 sentences. For each sentence, you have to decide how much the sentence applies to you as a working person, by clicking the appropriate button, from the sliding scale beside it.”

4.1 The Test (Examples of Question Type)

| | | Occa- | Some- | Fre- | V. |
|---|---|---|---|---|---|
| | Rarely | sionally | times | quently | Freq |
| | True | True | True | True | True |
| I do things “by the | [symbol] | [symbol] | [symbol] | [symbol] | [symbol] |
| book” even if it | | | | | |
| takes me longer to | | | | | |
| finish tasks. | | | | | |
| It is easy for me to | [symbol] | [symbol] | [symbol] | [symbol] | [symbol] |
| get distracted from | | | | | |
| a task. | | | | | |
| Following a routine | [symbol] | [symbol] | [symbol] | [symbol] | [symbol] |
| gives me a sense of | | | | | |
| comfort. | | | | | |
| I would rather spend | [symbol] | [symbol] | [symbol] | [symbol] | [symbol] |
| time with a couple | | | | | |
| of friends than attend | | | | | |
| a big party. | | | | | |
| When talking with | [symbol] | [symbol] | [symbol] | [symbol] | [symbol] |
| others, I mostly | | | | | |
| listen and keep | | | | | |
| my opinions to myself. | | | | | |

A summary result is given at a screen 22: “This information has also been sent to the e-mail address that you provided us with earlier. This result defines who you are, based on the answers you gave us. It makes you match-able to the same characteristics that an employer has given us, or will give us. If you add these characteristics to some basic information that we'll ask of you later in the process, it narrows you down to one of very few good matches, and makes your and the employer's job much easier.”

Screen 26 explains the available services and charges, and asks, do you want to go further down the road and use this information and the other stuff we'll collect to look for jobs? [YES] If yes is selected a new account screen 28 appears:

4.2 Create Account (Screen 28)

All fields are Required
Name: XXYXX XXXXXXX (Not given out by eBullpen)
Address: XXXXXXXXXXX, XXXXXXXX (Not given out by eBullpen, use billing address for your credit card)
Zip: XXXXX (Used for geographical matching)
The Industry you want to be considered for: (Pull Down) (used for matching)
Your Discipline: (marketing, accounts, etc) (Pull Down) (used for matching)
Level: (President, Director, Supervisor, etc) (Pull Down) (used for matching)
Desired Compensation Level (enter full dollars and no cents) per (hour/annum) (used for matching)
Type of work (full-time, part-time, temporary, seasonal, consultant)
Credit Card Type XXXX (not given out by eBullpen)
Credit Card # XXXX-XXXX-XXXX-XXXX (Not given out by eBullpen)
Expiration Date XX/XX (not given out by eBullpen)
CVV: XXX (not given out) (what's this)

Next, a click agreement to terms is requested (30), and a Create Password/choose subscription level screen 32 appears, followed by:

Thanks for submitting your information to us at eBullpen. Shortly you will receive confirmation of your subscription, and password, and you can then login to eBullpen and see what's happening there. Please hang on while your credit card details are verified. (36)

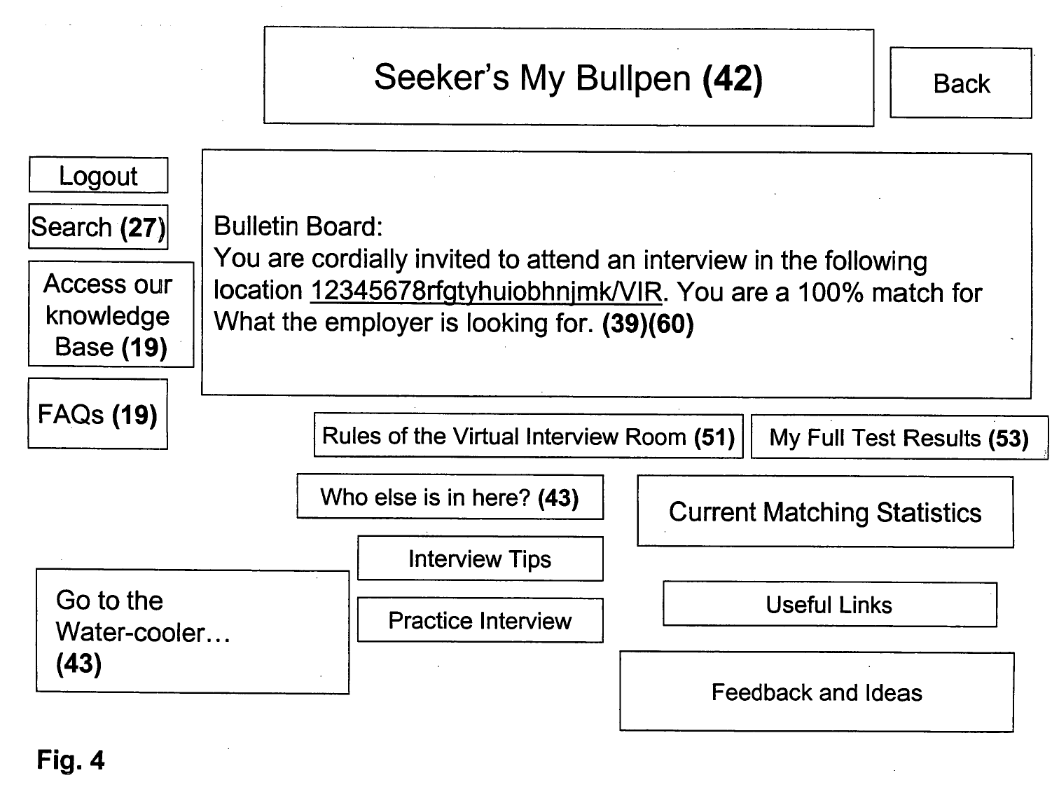

Congratulations, your subscription to eBullpen has been approved. Please follow the link below to login (38). FIG. 4 shows the first screen 42 “My Bullpen” when the job seeker is logged in. Further screens ‘Test Results’ (53) and Virtual interview Room (51 & 60) may be accessed, along with knowledge base and other features, such as the “watercooler” chat room area (43), and notifications of employers awaiting response in the Virtual Interview Room (51 & 60).

If a match is found, and an employer sends an invitation, screen 39 will advise: You are cordially invited to attend an interview in the following location 12345678rfgtyhuiobhnjmk/VIR. You are a 100% match for what the employer is looking for. In the case that a registered job seeker is not online, an E-mail advising the match is sent to the job seeker and inviting him/her to attend the VIR.

4.3 Virtual Interview Room (60)
Rules of the Interview Room (51):
You agree to us keeping records of this conversation
You agree you are here to discuss potential employment
You are in an initial Job Interview and will conduct yourself as such
No Bad Language
You understand that this may be a delayed action interview, as Employer and Employee may not be online at the same time.
Either side can terminate the interview at any time, by hitting the button on the lower right.
Passing of names, E-mail addresses, telephone numbers, or resumes, or arrangements for actual meetings are done at each party's own risk.

4.4 Employer

If the person identifies as an employer by selecting 31 at screen 10, further screens 70-102 explain the process and then sequence through it as follows.

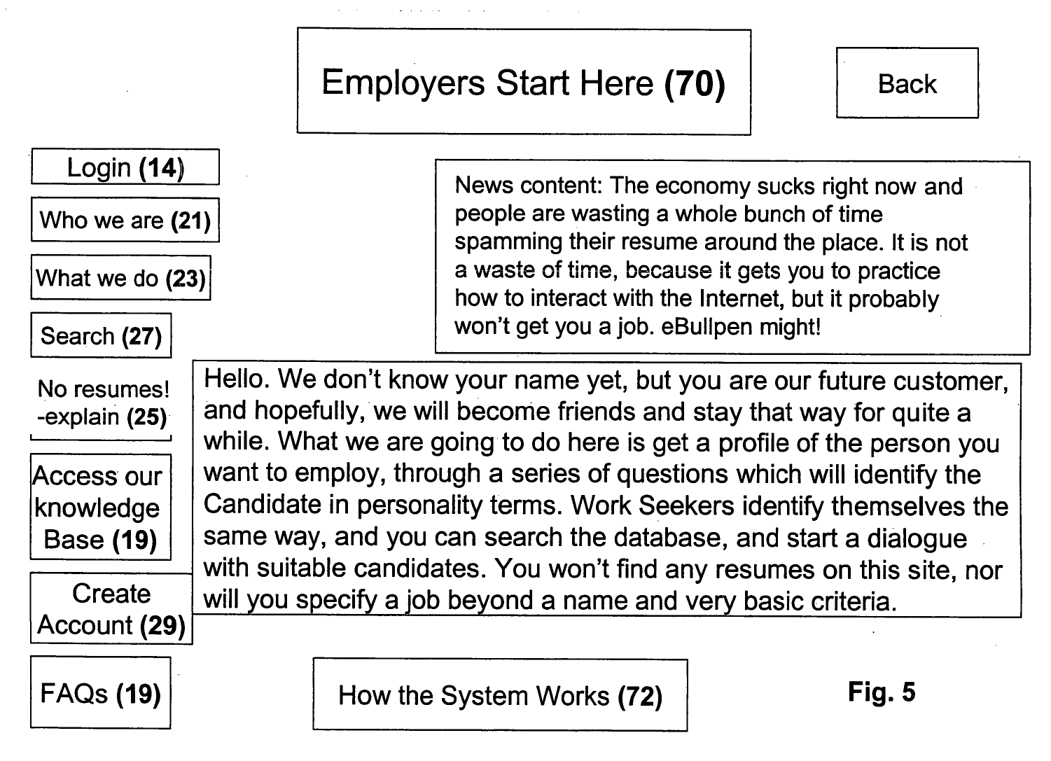

Screen 70 “Employers Start Here” (see FIG. 5) states: “What we are going to do here is get a profile of the person you want to employ, through a series of questions/statements which will identify the candidate in personality terms. Job seekers identify themselves in a similar way, and you can search the database, and start a dialogue with suitable candidates. You won't find any resumes on this site, nor will you specify a job beyond a name and very basic criteria. Screen 70 offers most of the same selections as screen 12 (FIG. 3), explained above, as indicated in FIG. 5.

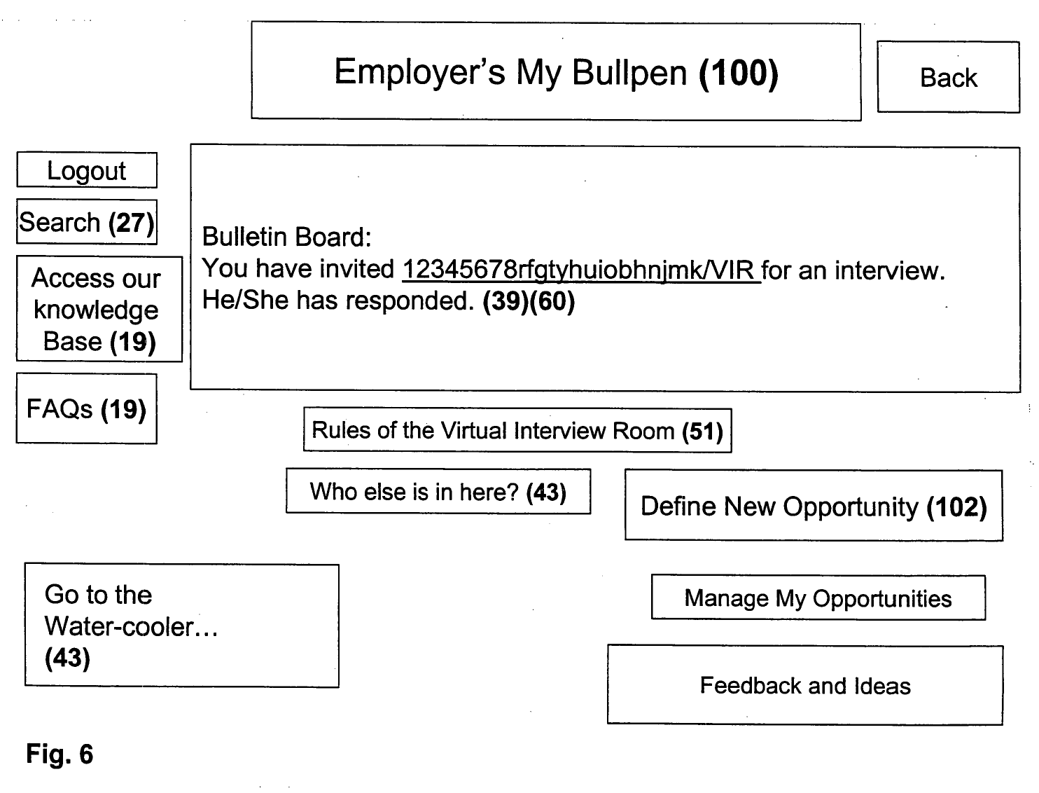

A screen 72 (see FIG. 6) explains how the system works: ”eBullpen gives job seekers a short (15 minutes, max) assessment, which establishes their personality traits, and tells them and others how they see and react to the world. There are no wrong answers to the test. They subscribe to our site for $10 a month's listing in our database. If they subscribe, we ask their geography (zipcode), preferred Industry to work in, preferred discipline (marketing, accounts, etc) level they have reached (worker, manager, director, VP), minimum salary level they desire (and can prove to a prospective employer), and type of work (F/T, P/T, Temp, Independent Contractor). Once subscribed, they get into their own area of the bullpen, where they can see activity, chat with others, get into a Virtual Interview Room with somebody who has found them (maybe you). On your side, once you are subscribed, we will give you a mechanism to manage the job opportunities you wish to fill, and for each, and specify the same criteria in the person you are looking for. A search is made of our database for suitable matches, which are generated to you in terms of percentage match. You look at that result, and can then start a dialogue with the matching individuals. Why don't you try the test the job seeker takes, It will explain a lot, and it's on us!”

4.5 Sample Test
[Take the Test (18, 20)] (optional—same test as described above—20) Test results are then given (22), as above, if this option is chosen.
If the employer wishes to continue, at screen 80, screen 88 appears, allowing them to create an account, similar to the job seeker, but including company information, to subscribe as an employer. They see our terms and conditions (30) and choose a subscription level (83), based on their number of expected searches, over time.

Create New eBullpen Account (88):
All fields are Required
Your Name: XXXXX XXXXXXX (Not given out by eBullpen)
Your Company: XXXXXXXXXXX LLC (Not given out by eBullpen)
Address: XXXXXXXXXXX, XXXXXXXX (Not given out by eBullpen, use billing address for your credit card)
Your Zip: XXXXX (Not given out by eBullpen)
Credit Card Type XXXX (not given out by eBullpen)
Credit Card # XXXX-XXXX-XXXX-XXXX (Not given out by eBullpen)
Expiration Date XX/XX (not given out by eBullpen)
CVV: XXX (not given out) (what's this)

4.8 General Information

Subscription Level: Choose from 3 different options/select password (83).

Terms and Conditions (30):

“Thanks for submitting your information to us at eBullpen (89). Shortly you will receive confirmation of your subscription, and password, and you can then login to eBullpen and see what's happening there” (100). Please hang on while your credit card details are verified . . .

Congratulations, your subscription to eBullpen has been approved (96). Please follow the link below to login (96).

4.9 Dedicated Area

Referring to FIG. 6, a screen 100 appears: (name) “Congratulations, you are in the system. The system now has your information and is ready to give you access to the search engine. You may contact any of the members from your search results, and invite them to our Virtual Interview Rooms™. You can see which jobs you are searching on the bulletin board and see if anybody has left you a message in one of the VIR's. Don't worry if you are not logged in when you get responses. You will be sent an E-mail, telling you, and giving you a link to go straight there. This screen is like a control panel, Pass your cursor over each of the buttons to see what they do.” Screen 100 includes most of the selections found in screen 42 (FIG. 4), but allows creation of new opportunities to search (102), management tools for those opportunities, and the ability to invite candidates to a Virtual Interview Room.

Create New Opportunity (102); All fields are Required
Name this Search: XXXXXXXXX
Zip code the employee will work in: XXXXX (Used for geographical matching)
The Industry that this opportunity is in: (Pull Down) (used for matching)
The Discipline: (marketing, accounts, etc) (Pull Down) (used for matching)
Level: (President, Director, Supervisor, etc) (Pull Down) (used for matching)
Compensation Level (enter full dollars and no cents) per (hour/annum) (used for matching)
Type of work (full-time, part-time, temporary, seasonal, consultant)

Create profile of desired employee by answering scaled questions similar in nature, but not identical to the Job Seekers' questions, couched in terms of worker behaviors.

4.7 The Employee Definition

TEST (same as above-described test)

“The Employee you are looking for is defined within our system. Now, are you ready to run the search?”

“Your search produced 3 100% matches and 17 matches in the range 70-99% match. Would you like to access these people now, or save the search to your bullpen page?”

“Full Search Results (102) for Job: Cook
dfghjkrtyuio345678 %match 100
Hjklnnm,hjklm,.uio90 %match 100
18 others . . . ”

Virtual Interview Room (60)
“Rules of the Interview Room (51) (same as job seekers) I agree to these rules eBullpen: Please introduce yourself, company and available position to this person, who is currently living in zip code 60051. When you do, he/she will be alerted if logged on to eBullpen, or E-mailed with the need to come here and respond, if not. Good luck!”

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

1. An employment method comprising:
obtaining a set of job seeker information from each of a plurality of job seekers, said job seeker information comprising, for each job seeker, basic qualification criteria and personality information;
obtaining a set of opportunity information from each of a plurality of employers, said opportunity information comprising for each opportunity, basic qualification criteria and personality information;
searching for a match in accordance with predetermined criteria between said sets of employer information and said sets of job seeker information, and
when a match is found, notifying at least one of a corresponding job seeker and a corresponding employer of said match.

2. The method of claim 1 and further including providing a forum for an interview between a job seeker and an employer.

3. The method of claim 2, wherein said forum comprises an online forum.

4. The method of claim 1, wherein said obtaining and said notifying are performed on an online web site.

5. The method of claim 1, and further including assigning a percentage value to each match, based upon a proportion of information found to match between each set of job seeker information and each set of employer information.

6. The method of claim 5, wherein said notifying further comprises notifying a corresponding employer of a percentage value assigned to each match.

7. The method of claim 1 wherein obtaining personality information from the job seeker comprises administering a personality test to said job seeker, interpreting results of said personality test and storing resulting interpretations.

8. The method of claim 1 wherein obtaining personality information from an employer comprises administering a personality test to said employer in which the employer is instructed to answer in accordance with desired personality traits of a desired employee, interpreting results of said test and storing resulting interpretations.

9. The method of claim 7 wherein obtaining personality information from an employer comprises administering a personality test to said employer in which the employer is instructed to answer in accordance with desired personality traits of a desired employee, interpreting results of said test and storing resulting interpretations.

10. The method of claim 4, and further including providing each job seeker and each employer with a personal page, including a bulletin board for displaying match information.

11. The method of claim 10, wherein said personal page further includes means for scheduling online interviews.

12. A method for making a connection with an employer, comprising:
a job seeker providing job seeker information comprising basic qualification criteria and personality information, and requesting inclusion of said job seeker information in a database accessible by employers for a search and report of any matches between opportunity information from said employers and said job seeker information from a plurality of job seekers, said opportunity information comprising for each opportunity, basic qualification criteria and personality information.

13. The method of claim 12, wherein said providing and said requesting inclusion are performed on an online web site.

14. The method of claim 13 and further including accessing an online forum for an interview between said job seeker and an employer.

15. The method of claim 12 wherein providing personality information comprises taking a personality test.

16. The method of claim 14, and further including accessing a personal page, including a bulletin board for displaying match information and means for scheduling online interviews.

17. A method of making a connection with a job seeker, comprising:
an employer providing opportunity information comprising basic qualification criteria and personality information; and requesting a search for and report of any matches between said opportunity information and job seeker information comprising, for each job seeker, basic qualification criteria and personality information.

18. The method of claim 17 and further including requesting an online forum for an interview between said employer and a job seeker.

19. The method of claim 17, wherein said providing and said requesting a search are performed on an online web site.

20. The method of claim 17 wherein providing personality information comprises taking a personality test in which the employer answers in accordance with desired personality traits of a desired employee.

21. The method of claim 19, and further including accessing a personal page, including a bulletin board for displaying match information and means for scheduling online interviews.

22. An employment method comprising performing the following steps in an online environment:
obtaining a set of job seeker information from each of a plurality of job seekers, said job seeker information comprising, for each job seeker, at least basic qualification criteria;
obtaining a set of opportunity information from each of a plurality of employers, said opportunity information comprising for each opportunity, at least basic qualification criteria;
searching for a match in accordance with predetermined criteria between said sets of employer information and said sets of job seeker information, and
when a match is found, notifying at least one of a corresponding job seeker and a corresponding employer of said match; and
providing an online forum for an interview between a job seeker and an employer.

23. An employment method comprising performing the following steps in an online environment:
obtaining a set of job seeker information from each of a plurality of job seekers, said job seeker information comprising, for each job seeker, basic qualification criteria and personality information;
obtaining a set of opportunity information from each of a plurality of employers, said opportunity information comprising for each opportunity,
at least basic qualification criteria;
searching for a match in accordance with predetermined criteria between said sets of employer information and said sets of job seeker information;
when a match is found, notifying at least one of a corresponding job seeker and a corresponding employer of said match, and
assigning a percentage value to each match, based upon a proportion of information found to match between each set of job seeker information and each set of employer information.

24. The method of claim 23, wherein said notifying further comprises notifying a corresponding employer of a percentage value assigned to each match.
